(19) United States
(12) Patent Application Publication
(10) Pub. No.: US 2025/0327518 A1
(43) Pub. Date: Oct. 23, 2025

(54) SEALING RING FOR RECIPROCATING PUMP

(71) Applicant: GD Energy Products, LLC, Tulsa, OK (US)

(72) Inventor: James Robert Yanus, Tulsa, OK (US)

(21) Appl. No.: 18/958,083

(22) Filed: Nov. 25, 2024

Related U.S. Application Data
(60) Provisional application No. 63/637,145, filed on Apr. 22, 2024.

(51) Int. Cl. F16J 15/3204; F04B 39/04; F16J 15/3284

(52) U.S. Cl. CPC F16J 15/3204; F04B 39/041; F16J 15/3284

(57) ABSTRACT

A sealing ring includes a planar upstream surface, a tapered downstream surface disposed opposite of the planar upstream surface, and an arcuate inner surface extending convexly from the planar upstream surface toward the tapered downstream surface. The arcuate inner surface is configured to engage with a reciprocating element of the reciprocating pump.

### CROSS-REFERENCE TO PRIOR APPLICATION

This application claims priority to and the benefit of U.S. Provisional Application No. 63/637,145, entitled “SEALING RING FOR RECIPROCATING PUMP,” filed Apr. 22, 2024, and hereby incorporated by reference in its entirety for all purposes.

### TECHNICAL FIELD

The present disclosure relates to the field of high pressure reciprocating pumps and, in particular, a sealing ring for high pressure reciprocating pumps.

### BACKGROUND

High pressure reciprocating pumps are often used to deliver high pressure fluids during earth drilling operations. A packing arrangement is provided to seal against a reciprocating element to reduce the likelihood of leakage of fluid between a pump casing and the reciprocating element. The packing arrangement may also protect the reciprocating element from grinding against potentially abrasive components contained in the fluid.

### SUMMARY

The present application relates to a sealing ring for a packing arrangement of a high pressure reciprocating pump. The sealing ring may be provided independent of any other elements incorporated in a packing arrangement, and/or the sealing ring may be incorporated in a reciprocating pump.

In accordance with at least one embodiment, the present application is directed to a sealing ring for a packing arrangement of a reciprocating pump. The sealing ring includes a planar upstream surface, a tapered downstream surface disposed opposite of the planar upstream surface, and an arcuate inner surface extending convexly from the planar upstream surface toward the tapered downstream surface. The arcuate inner surface is configured to engage with a reciprocating element of the reciprocating pump.

In accordance with at least one other embodiment, the present application is directed to a sealing ring assembly for a packing arrangement of a reciprocating pump. The sealing ring assembly includes a first ring having a planar downstream face and a second ring having a planar upstream face configured to engage the planar downstream face of the first ring and an inner face extending arcuately and convexly from the planar upstream face in a downward direction.

In accordance with at least one further embodiment, the present application is directed to a sealing ring for a packing arrangement of a reciprocating pump. The sealing ring includes an upstream surface, an arcuate inner surface extending convexly from the upstream surface, and a downstream surface extending from the arcuate inner surface. The arcuate inner surface is configured to engage with a reciprocating element of the reciprocating pump.

### BRIEF DESCRIPTION OF THE DRAWINGS

To complete the description and in order to provide for a better understanding of the present disclosure, a set of drawings is provided. The drawings form an integral part of the description and illustrate an embodiment of the present disclosure, which should not be interpreted as restricting the scope of the disclosure, but just as an example of how the disclosure can be carried out. The drawings comprise the following figures:

FIG. 1 is a perspective view of a reciprocating pump including a fluid end, with which aspects of the present disclosure may be incorporated.

FIG. 2 is a cross-sectional view of the reciprocating pump of FIG. 1, taken along a plane that is parallel to a central axis.

FIG. 3 is a cross-sectional view of a packing arrangement for a reciprocating pump, in accordance with an embodiment of the present disclosure.

FIGS. 4A-4F provide schematic cross-sectional views of sealing rings of a packing arrangement for a reciprocating pump, in accordance with embodiments of the present disclosure.

### DETAILED DESCRIPTION

The following description is not to be taken in a limiting sense but is given solely for the purpose of describing the broad principles of the disclosure. Embodiments of the disclosure will be described by way of example, with reference to the above-mentioned drawings showing elements and results according to the present disclosure.

A reciprocating pump includes a reciprocating element that moves (e.g., a plunger that translates) within a casing. For example, an intake stroke of the reciprocating element may reduce a pressure within a pumping chamber of the reciprocating pump to draw fluid into the pumping chamber. A discharge stroke of the reciprocating element may increase the pressure within the pumping chamber to pressurize the fluid and discharge the pressurized fluid. During operation of the reciprocating pump, the reciprocating element alternates between the intake stroke and the discharge stroke to repeatedly provide pressurized fluid.

A packing arrangement is provided to block fluid flow between the reciprocating element (e.g., a plunger) and the casing. To this end, the packing arrangement is positioned to sealingly engage with the reciprocating element and the casing. For instance, the packing arrangement may include a sealing ring assembly (e.g., an annular sealing ring assembly) with a sealing ring and a junk ring. The sealing ring includes an upstream surface configured to engage with a downstream surface of the junk ring. Additionally, the sealing ring includes an arcuate inner surface extending from the upstream surface and configured to contact the reciprocating element. By way of example, compressing the sealing ring against the junk ring may deform the sealing ring by expanding the arcuate inner surface further inward toward the reciprocating element, thereby increasing sealed engagement of the sealing ring with the reciprocating element.

In at least some instances, the arcuate inner surface extends directly from the upstream surface to avoid creating a pedestal or a pocket that otherwise can entrap debris, which may potentially grind against and wear the sealing ring (e.g., caused by movement of the reciprocating element along the sealing ring). That is, the arcuate inner surface may be directly connected to and/or be contiguous with the upstream surface. Thus, the arrangement of the arcuate inner surface relative to the upstream surface may help maintain a structural integrity of the sealing ring, thereby increasing a useful lifespan of the sealing ring.

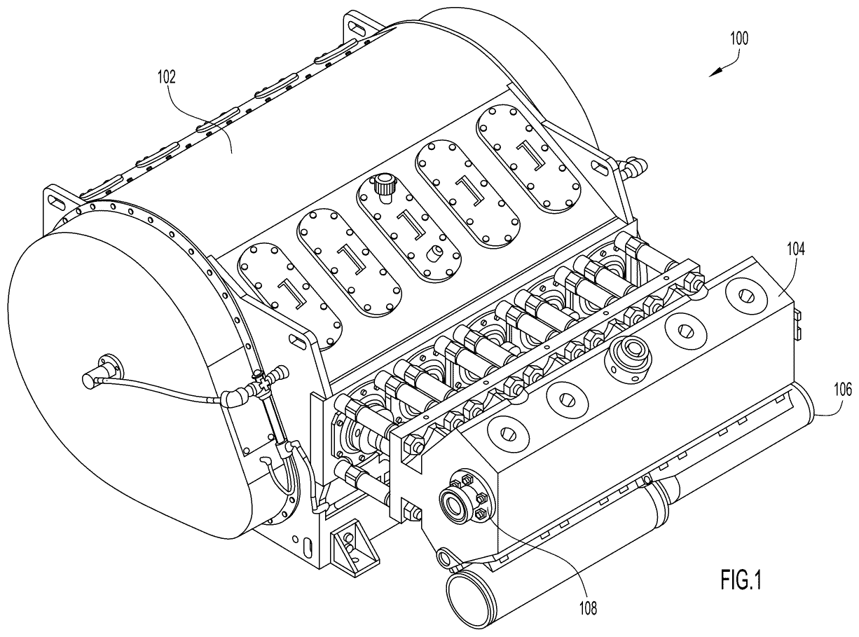

FIG. 1 is an exemplary embodiment of a reciprocating pump 100 in which the sealing ring assembly (e.g., an annular sealing ring assembly) presented herein may be included. The reciprocating pump 100 includes a power end 102 and a fluid end 104. The power end 102 includes a crankshaft that drives a plurality of reciprocating elements within the fluid end 104 to pump fluid at high pressure. Generally, the power end 102 is capable of generating forces sufficient to cause the fluid end 104 to deliver high pressure fluids to earth drilling operations. For example, the power end 102 may be configured to support hydraulic fracturing (i.e., fracking) operations, where fracking liquid (e.g., a mixture of water and sand) is injected into rock formations at high pressures to allow natural oil and gas to be extracted from the rock formations.

Often, the reciprocating pump 100 may be quite large and may, for example, be supported by a semi-tractor truck (“semi”) that can move the reciprocating pump 100 to and from a well. For example, in some instances, a semi may move the reciprocating pump 100 off a well to perform maintenance on the reciprocating pump 100. However, a reciprocating pump 100 is typically moved off a well only when a replacement pump (and an associated semi) is available to move into place at the well, which may be rare. Thus, often, the reciprocating pump 100 is taken offline at a well and maintenance is performed while the reciprocating pump 100 remains on the well. If not for this maintenance, the reciprocating pump 100 could operate continuously to extract natural oil and gas. Consequently, any improvements that extend the lifespan of components of the reciprocating pump 100, especially typical “wear” components, and extend the time between maintenance operations (i.e., between downtime) are highly desirable.

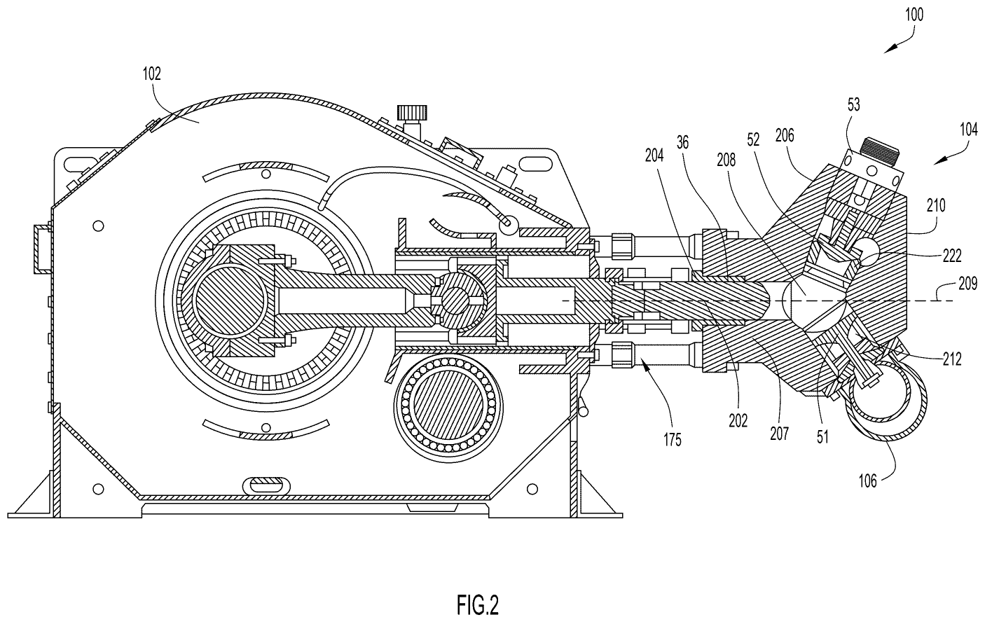

FIG. 2 shows a side, cross-sectional view of the reciprocating pump 100 taken along a central axis 209 of one of the reciprocating elements 202 included in the reciprocating pump 100. Thus, FIG. 2 depicts a single pumping chamber 208. However, it should be understood that a fluid end 104 can include multiple pumping chambers 208 arranged side-by-side. In fact, in at least some embodiments (e.g., the embodiment of FIG. 1), a casing 206 of the fluid end 104 forms a plurality of pumping chambers 208, and each pumping chamber 208 includes a reciprocating element 202 that reciprocates within the casing 206. However, side-by-side pumping chambers 208 need not be defined by a single casing 206. For example, in some embodiments, the fluid end 104 may be modular, and different casing segments may house one or more pumping chambers 208. In any case, the one or more pumping chambers 208 are arranged side-by-side so that corresponding conduits are positioned adjacent to each other and generate substantially parallel pumping action. Specifically, with each stroke of the reciprocating element 202, low pressure fluid is drawn into the pumping chamber 208 and high pressure fluid is discharged from the pumping chamber 208.

In the depicted embodiment, the fluid end 104 includes a first bore 204 that intersects an inlet bore 212 and an outlet bore 222. The inlet bore 212 defines a fluid path through the fluid end 104 that connects the pumping chamber 208 to a piping system 106 delivering fluid to the fluid end 104. Meanwhile, the outlet bore 222 allows compressed fluid to exit the fluid end 104. The bores 212, 222 may include valve components 51, 52, respectively, (e.g., one-way valves) that allow the bores 212 and 222 to selectively open and deliver a fluid through the fluid end 104 during operation. Typically, the valve components 51 in the inlet bore 212 may be secured therein by the piping system 106. Meanwhile, the valve components 52 in the outlet bore 222 may be secured therein by a closure assembly 53 that, in the example illustrated in FIG. 2, is removably coupled to the fluid end 104 via threads.

In operation, fluid may enter fluid end 104 via outer openings of the inlet bores 212 and exit fluid end 104 via outer openings of the outlet bores 222. More specifically, fluid may enter the inlet bores 212 via pipes of the piping system 106, flow through the pumping chamber 208 (e.g., due to reciprocation of the reciprocating elements 202), and then through the outlet bores 222 into a channel 108 (see FIG. 1). However, the piping system 106 and the channel 108 are merely example conduits and, in various embodiments, the fluid end 104 may receive and discharge fluid via any number of pipes and/or conduits, along pathways of any desirable size or shape.

Meanwhile, each of the first bores 204 defines, at least in part, a cylinder for the reciprocating elements 202 and/or connects the casing 206 to a cylinder for the reciprocating elements 202. Reciprocation of the reciprocating element 202 in or adjacent to the first bore 204, which may be referred to as a reciprocation bore (or, for fracking applications, a plunger bore), draws fluid into the pumping chamber 208 via the inlet bore 212 and pumps the fluid out of the pumping chamber 208 via the outlet bore 222. Additionally, a casing segment 207 houses a packing arrangement or assembly 36 configured to seal against the reciprocating element 202 disposed interiorly of the packing arrangement 36. The packing arrangement 36 therefore blocks fluid flow between the casing 206 and the reciprocating element 202 (e.g., to force fluid flow to the outlet bore 222). Moreover, the packing arrangement 36 can block abrasive material (e.g., debris) within the fluid from imparting an excessive amount of force against the casing 206 and/or against the reciprocating element 202 that could otherwise change a geometry of the casing 206 and/or of the reciprocating element 202. Thus, the packing arrangement 36 may help maintain a desirable structural integrity of the casing 206 and/or of the reciprocating element 202 to improve a useful lifespan of the reciprocating pump 100.

To help provide access to the pumping chamber 208 and/or components positioned therein, such as for performing maintenance operations, some fluid ends 104 have access bores that are often aligned with (and sometimes coaxial with) the first bore 204. Other fluid ends 104 need not include an access bore and, thus, such an access bore is not illustrated in FIGS. 1 and 2. Regardless of whether the fluid end 104 includes an access bore, the packing arrangement 36 typically is to be replaced from an outer opening of the first bore 204 (i.e., a side of the first bore 204 aligned with the external surface 210 of the casing 206). At the same time, to operate properly, the fluid end 104 is to be securely and stably coupled to the power end 102. Thus, the fluid end 104 is directly coupled to the power end 102 with relatively short couplers 175, and at least a portion of the reciprocating pump 100 is to be disassembled to access the first bore 204, e.g., to replace packing arrangement 36.

In various embodiments, the fluid end 104 may be shaped differently and/or have different features but may still generally perform the same functions, define similar structures, and house similar components. For example, while the fluid end 104 includes a first bore 204 that intersects an inlet bore 212 and an outlet bore 222 at skewed angles, other fluid ends may include any number of bores arranged along any desired angle or angles, for example, to intersect the first bore 204 (and/or an access bore) substantially orthogonally and/or so that two or more bores are substantially coaxial. Generally, the bores 212, 222, as well as any other bores (i.e., segments, conduits, etc.), may intersect to form the pumping chamber 208, may be cylindrical or non-cylindrical, and may define openings at an external surface 210 of the casing 206. Additionally, the bores 212, 222, as well as any other bores (i.e., segments, conduits, etc.), may receive various components or structures, such as sealing assemblies or components thereof.

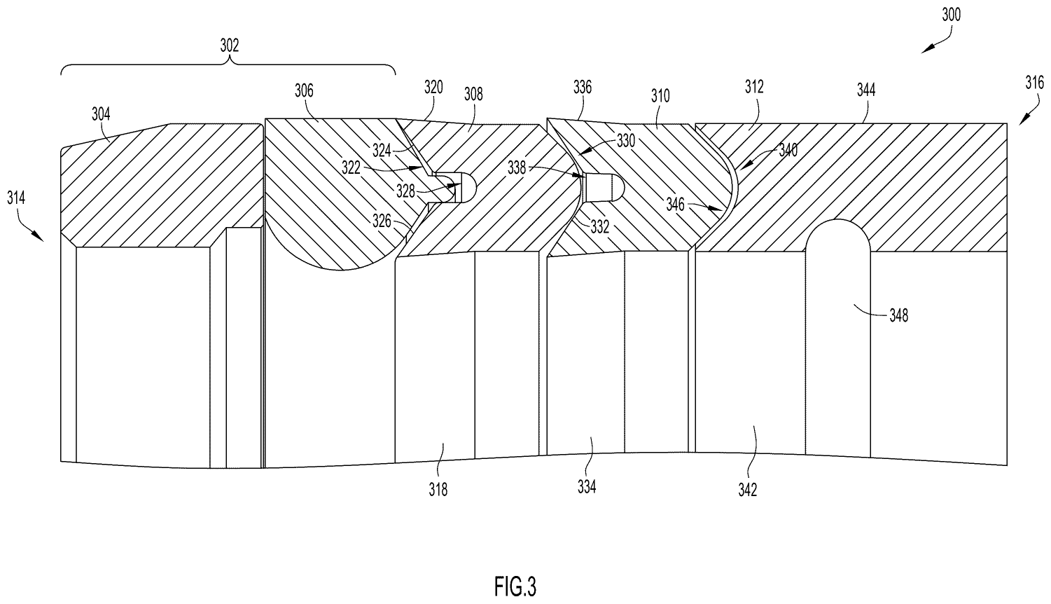

FIG. 3 illustrates a side cross-sectional view of a packing arrangement 300 (e.g., the packing arrangement 36). For example, the packing arrangement 300 may be positioned within a packing box formed as a part of the casing 206 and/or a stuffing box coupled to the casing 206. While the packing arrangement 300 is disposed in the casing 206, compression of the packing arrangement 300 causes the packing arrangement 300 to seal against the casing 206 and the reciprocating element 202. The packing arrangement 300 includes a first ring 304 (e.g., a junk ring) and a second ring 306 (e.g., a sealing ring) configured to engage with one another. The packing arrangement 300 also includes a first pressure ring 308 configured to mate with the second ring 306, a second pressure ring 310 configured to mate with the first pressure ring 308, and a lantern ring 312 configured to mate with the second pressure ring 310.

The first ring 304, the second ring 306, the first pressure ring 308, the second pressure ring 310, and the lantern ring 312 are positioned sequentially from one another in a downstream direction, which is a direction from a high pressure side 314 (e.g., adjacent to the first ring 304) to a low pressure side 316 (e.g., adjacent to the lantern ring 312) of the packing arrangement 300. Although the first ring 304 and the second ring 306 are positioned most upstream (e.g., most adjacent to the high pressure side 314) as compared to a remainder of the packing arrangement 300, in other embodiments, there may be additional rings that are more upstream than the first ring 304 and the second ring 306. Indeed, the packing arrangement 300 may include any quantity or combination of ring components (e.g., any quantity of pressure rings or sealing rings) arranged in any suitable manner.

The first pressure ring 308 is an annular ring that includes a tapered inner surface 318 configured to face and abut the reciprocating element 202, as well as a tapered outer surface 320, opposite the tapered inner surface 318, facing away from the reciprocating element 202 (e.g., to abut the packing box). The first pressure ring 308 further includes an upstream side 322 that includes a first upstream surface 324 and a second upstream surface 326 extending toward one another in the downstream direction to form a chevron (e.g., a female chevron) configuration. Each of the upstream surfaces 324, 326 extends to meet at an aperture 328, which provides a relief space that allow the upstream surfaces 324, 326 to flex (e.g., to become more parallel relative to one another) in response to compression of the first pressure ring 308 between the casing 206 and the reciprocating element 202. The first pressure ring 308 also includes a downstream side 330 that includes an arcuate downstream surface 332. For example, the arcuate downstream surface 332 may form a male chevron configuration.

The second pressure ring 310 includes similar features as the first pressure ring 308 in the illustrated embodiment. That is, the second pressure ring 310 includes a tapered inner surface 334 similar to the tapered inner surface 318 of the first pressure ring 308, a tapered outer surface 336 similar to the tapered outer surface 320 of the first pressure ring 308, an upstream side 338 similar to the upstream side 322 of the first pressure ring 308 (e.g., the upstream side 338 forms a female chevron configuration and includes an aperture configured to mate with the arcuate downstream surface 332 of the first pressure ring 308), and a downstream side 340 similar to the downstream side 330 of the first pressure ring 308 (e.g., the downstream side 340 forms a male chevron configuration). However, the respective features of the first pressure ring 308 and of the second pressure ring 310 may have different dimensions than one another. Moreover, in alternative embodiments, the first pressure ring 308 and the second pressure ring 310 may have different features and dissimilar appearances.

In any case, the pressure rings 308, 310 may be primary sealing components of the packing arrangements in that the pressure rings 308, 310 receive a large portion of pressure applied by high pressure fluid within the pumping chamber 208. Therefore, the pressure rings 308, 310 may be relatively stiff or inflexible to provide sufficient stability to avoid an undesirable change in geometry during compression. For example, the pressure rings 308, 310 may be formed from an elastomer impregnated aramid fabric.

The lantern ring 312 is an elongated annular ring that includes an inner surface 342 (e.g., a cylindrical inner surface) that faces the reciprocating element 202 and an outer surface 344 (e.g., a cylindrical outer surface) that faces away from the reciprocating element 202. The lantern ring 312 additionally includes an upstream side 346 configured to receive the downstream side 340 of the second pressure ring 310. To this end, the upstream side 346 of the lantern ring 312 may form a female chevron configuration to accommodate the male chevron configuration of the downstream side 340 of the second pressure ring 310. In some embodiments, the lantern ring 312 is formed from a metal, such as aluminum, bronze, or a combination thereof, to provide desirable rigidity and support. Moreover, the lantern ring 312 may, for example, include sealing elements (e.g., O-rings, annular seals), as well as a bore 348 that provides a flow path for a lubricant (e.g., oil) delivered to the packing arrangement 300 to enhance a function of the packing arrangement 300 while providing lubrication between the reciprocating element 202 and the packing arrangement 300 to facilitate relative movement between the reciprocating element 202 and the packing arrangement 300.

In some embodiments, the lantern ring 312 is compressed against the pressure rings 308, 310. Such compression may cause the packing arrangement 300 to expand radially inward toward the reciprocating element 202 and radially outward toward the casing. As a result, the packing arrangement 300 may better seal against the casing 206 and against the reciprocating element 202.

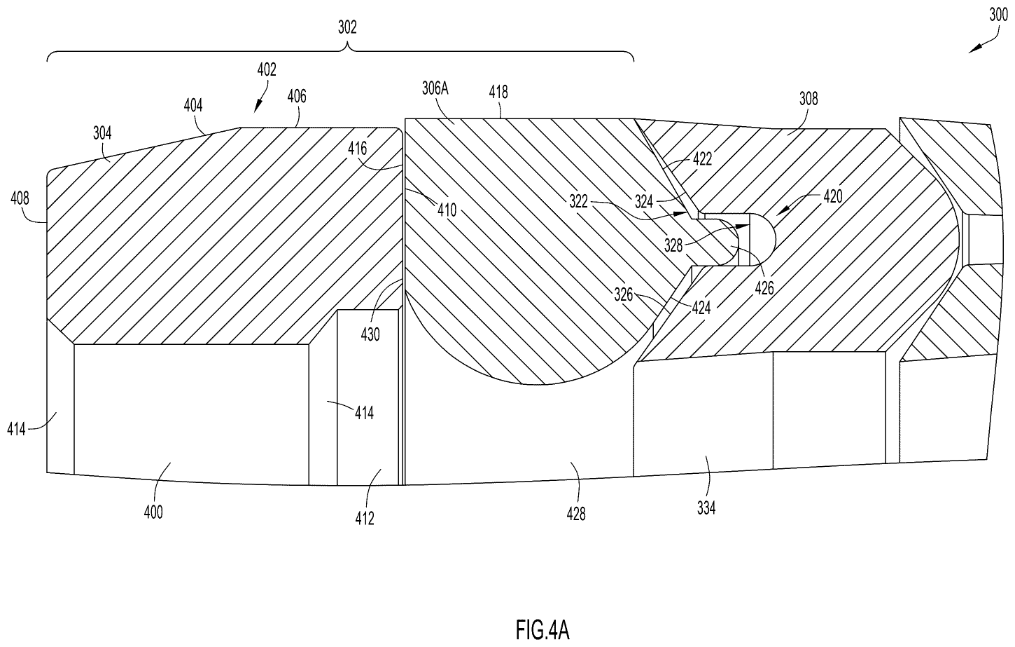

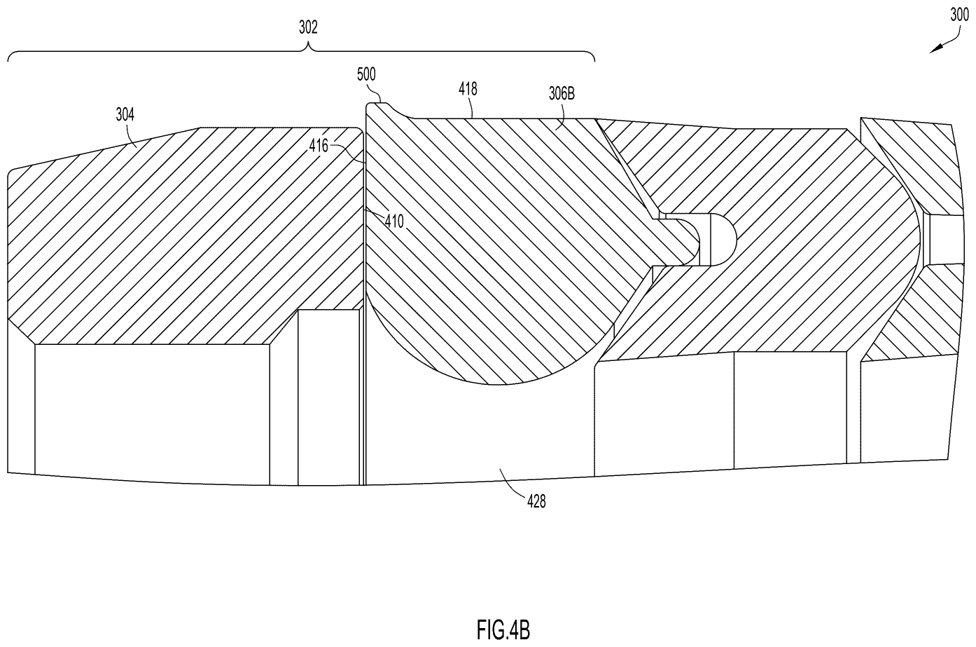

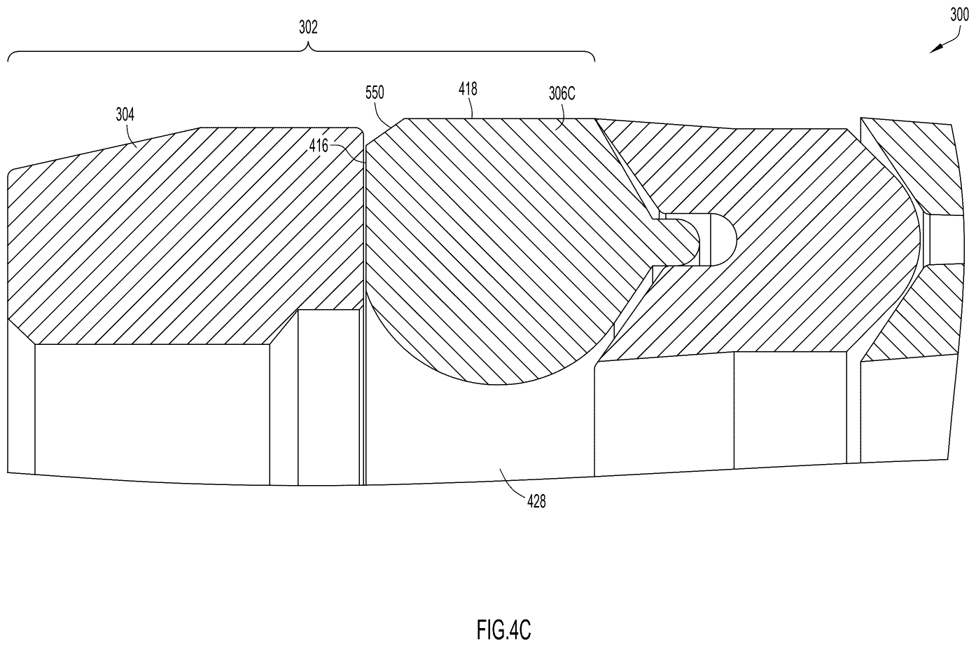

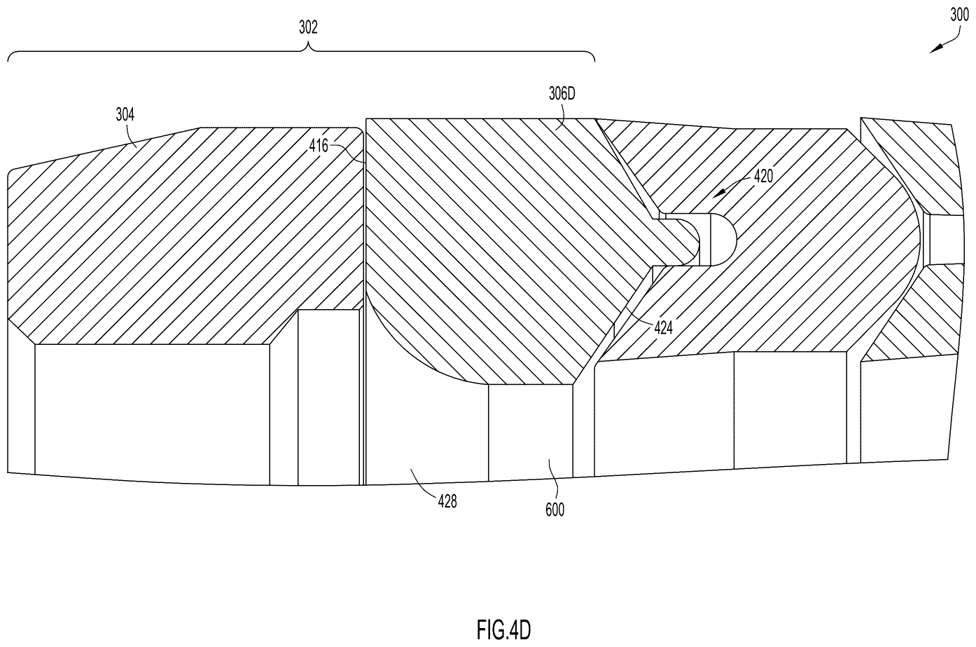

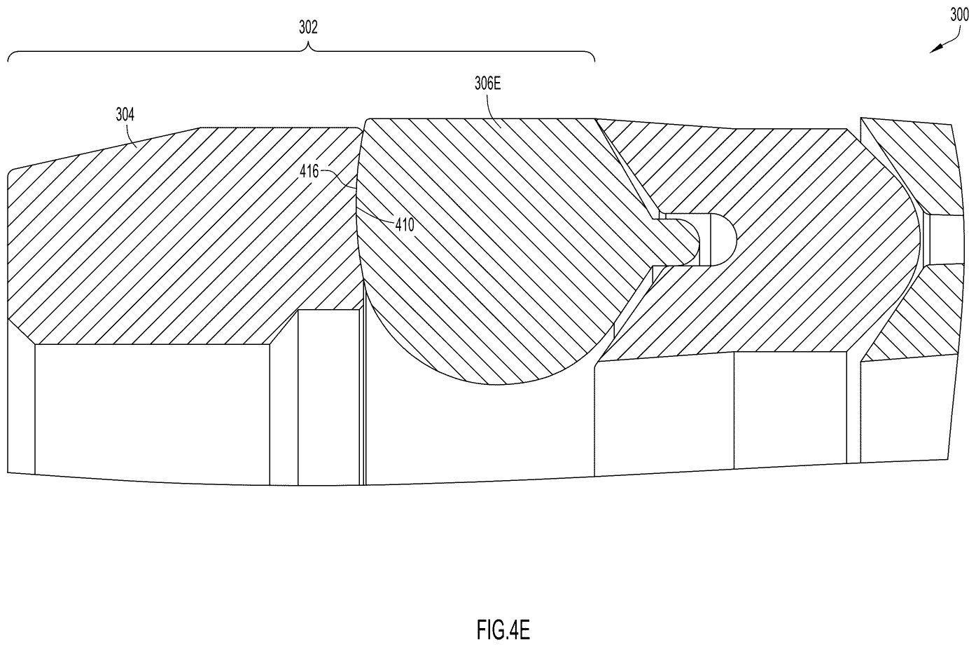

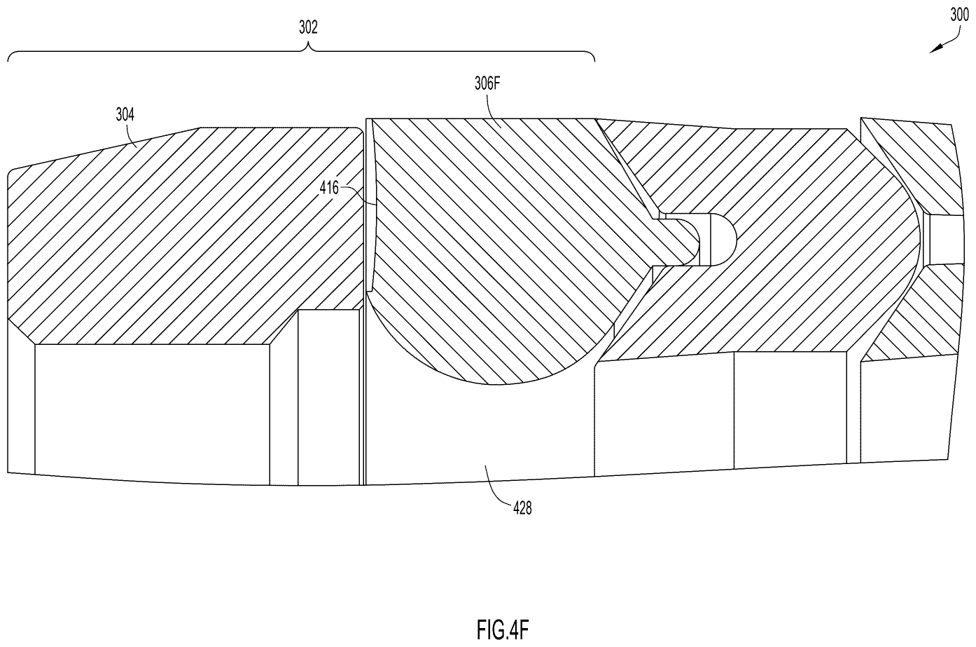

Each of FIGS. 4A-4F illustrates the packing arrangement 300 providing greater visualization of the first ring 304 and the second ring 306. FIG. 4A illustrates the first ring 304 engaged with a first embodiment of the second ring 306A. The first ring 304 includes a first inner surface 400 (e.g., a cylindrical inner surface) configured to face and abut the reciprocating element 202, as well as an outer surface 402 configured to face away from the reciprocating element 202. The outer surface 402 of the first ring 304 in the illustrated embodiment includes a tapered portion 404 and a cylindrical portion 406. The first ring 304 also includes a planar upstream surface 408 and a planar downstream surface 410. For example, the planar upstream surface 408 and the planar downstream surface 410 may extend approximately parallel to one another. The outer surface 402 extends between the planar upstream surface 408 and the planar downstream surface 410. The first ring 304 further includes a second inner surface 412 that extends from the planar downstream surface 410 and is offset from the first inner surface 400. For instance, the second inner surface 412 may be positioned more exteriorly (e.g., closer to the outer surface 402) relative to the first inner surface 400. Chamfered sections 414 connect the first inner surface 400 to the planar upstream surface 408 and to the second inner surface 412, respectively.

The second ring 306A includes an upstream surface 416 configured to engage with the planar downstream surface 410 of the first ring 304. In the illustrated embodiment, the upstream surface 416 is planar and is configured to be positioned approximately flush against the planar downstream surface 410. The second ring 306A also includes an outer surface 418, which is cylindrical in the illustrated embodiment and, for example, may extend perpendicular to the upstream surface 416. Further still, the second ring 306A includes a downstream side 420, opposite the upstream surface 416, having a first downstream surface 422 (e.g., extending to the outer surface 418) and a second downstream surface 424 that are tapered and extend toward one another in the downstream direction transverse to the upstream surface 416, such as to form a chevron (e.g., a male chevron) configuration. For example, the downstream surfaces 422, 424 extend to an extension 426 (e.g., a knob portion), which extends farther in the downstream direction. The downstream surfaces 422, 424 of the second ring 306A are configured to engage with the upstream surfaces 324, 326 of the first pressure ring 308, and the extension 426 of the second ring 306A is configured to extend into the aperture 328 of the first pressure ring 308, thereby causing the downstream side 420 of the second ring 306A to mate with the upstream side 322 of the first pressure ring 308. However, in additional or alternative embodiments, the downstream side 420 of the second ring 306A can have any other geometric configuration, such as a planar surface, configured to engage the upstream side 322 of the first pressure ring 308.

Further still, the second ring 306A includes an arcuate inner surface 428. In the illustrated embodiment, the arcuate inner surface 428 extends from the upstream surface 416 in the downstream direction and extends entirely from the upstream surface 416 to the second downstream surface 424. Thus, the arcuate inner surface 428 is directly connected and adjoined to the upstream surface 416 and the downstream surface 424. The arcuate inner surface 428 is configured to abut the reciprocating element 202 to provide a sealed engagement with the reciprocating element 202 (see FIG. 2). To this end, the arcuate inner surface 428 extends radially beyond the first ring 304 (e.g., the first inner surface 400) and the first pressure ring 308 (e.g., the tapered inner surface 334). The engagement between the arcuate inner surface 428 and the reciprocating element 202 may prevent or at least discourage fluid flow between the second ring 306A and the reciprocating element 202. Indeed, the arcuate inner surface 428 is configured to scrape debris off the reciprocating element 202 during movement of the reciprocating element 202 against the arcuate inner surface 428, thereby preventing or at least discouraging debris from being trapped and grinding against other components of the packing arrangement 300 (e.g., the pressure rings 308, 310).

Because the arcuate inner surface 428 extends directly from and is therefore contiguous/attached to the upstream surface 416, the arcuate inner surface 428 and the upstream surface 416 cooperatively form a vertex 430 avoids creating any pedestals, pockets, steps, or recesses at or adjacent to the upstream surface 416 and exposed to fluid pressurized by the reciprocating element. For example, such a pedestal may be subject to receiving concentrations of high pressure fluid and debris, and the debris trapped in the pedestal may grind against the second ring 306A to cause excessive wear. Thus, the arcuate inner surface 428 extending from the upstream surface 416 may limit wear of the second ring 306A. As such, the arrangement of the arcuate inner surface 428 may provide a sufficient seal against the reciprocating element 202 by maintaining abutment against the reciprocating element 202 without compromising the structural integrity and useful lifespan of the second ring 306A.

Additionally or alternatively, the specific arcuate shape of the inner surface 428 may avoid creating any pedestals, pockets, steps, or recesses that may be subject to receiving concentrations of high pressure fluid and debris. This is because the inner surface 428 extends convexly (e.g., entirely convexly) from the upstream surface 416 to the second downstream surface 424. That is, the inner surface 428 may not have or form any concave sections along its extension from the upstream surface 416 to the second downstream surface 424. By comparison, if a portion of inner surface 428 were concave, a pedestal and the issues associated therewith may be created. In fact, in the depicted embodiment, the inner surface 428 has a relatively constant convex curvature. The constant curvature may smooth and/or enhance the engagement with the reciprocating element 202. In addition, compressing the second ring 306A between the first ring 304 and the first pressure ring 308 deforms the second ring 306A to cause the arcuate inner surface 428 to expand radially inward toward the reciprocating element 202. Consequently, such compression improves the sealed engagement of the arcuate inner surface 428 against the reciprocating element 202. In certain embodiments, a portion of the second upstream surface 326 of the first pressure ring 308 may extend over the arcuate inner surface 428 of the second ring 306A to facilitate deformation of the second ring 306A and enable the second upstream surface 326 to contact the arcuate inner surface 428 during compression of the second ring 306A. Consequently, the first pressure ring 308 imparts a force that directly causes the arcuate inner surface 428 to expand radially inward.

In some embodiments, the second ring 306A may be composed of a resilient material, such as a homogeneous elastomer, a filled elastomer, a partially fabric reinforced elastomer, and/or a full fabric reinforced elastomer (e.g., thermoplastic polyurethane (TPU), thermoplastic copolyester (COPE), ethylene propylene diene monomer (EPDM), highly saturated nitrile rubber (HNBR)) to enable the second ring 306A (e.g., the arcuate inner surface 428) to expand and compress. Thus, the second ring 306A may deform in response to compressive forces (e.g., imparted by the first ring 304, imparted by the first pressure ring 308, imparted by the reciprocating element 202) to deform. Indeed, deforming the second ring 306A may help form the seal against the reciprocating element 202 without impeding movement of the reciprocating element 202 along the second ring 306A.

Meanwhile, the first ring 304 may be composed of a rigid material (e.g., a metal, a composite, a plastic) that has less resiliency than that of the second ring 306A to resist compressive forces imparted by the second ring 306A onto the first ring 304. By resisting deformation, the first ring 304 may impart a sufficient amount of force that deforms the second ring 306A (e.g., to expand the arcuate inner surface 428 inwardly toward the reciprocating element 202) during compression of the second ring 306A against the first ring 304.

FIG. 4B illustrates the first ring 304 engaged with a second embodiment of the second ring 306B. In the illustrated embodiment, the outer surface 418 of the second ring 306B includes an extended portion 500 that extends further outward. For instance, the extended portion 500 may extend the upstream surface 416 radially outward beyond the planar downstream surface 410 of the first ring to increase a size of the upstream surface 416 available for contact with the planar downstream surface 410. Consequently, the first ring 304 may better compress the second ring 306B to deform the second ring 306B (e.g., to extend the arcuate inner surface 428 further inward) for abutment against the reciprocating element 202.

FIG. 4C illustrates the first ring 304 engaged with a third embodiment of the second ring 306C. The illustrated second ring 306C includes a tapered portion 550 extending transversely from the upstream surface 416 to the outer surface 418. The tapered portion 550 may facilitate movement (e.g., rotation) of the upstream surface 416 relative to the outer surface 418. By way of example, such movement of the upstream surface 416 relative to the outer surface 418 during compression of the first ring 304 against the second ring 306C may cause the arcuate inner surface 428 to extend radially inward. Thus, the tapered portion 550 facilitates extending the arcuate inner surface 428 to engage with the reciprocating element 202.

FIG. 4D illustrates the first ring 304 engaged with a fourth embodiment of the second ring 306D. The arcuate inner surface 428 of the illustrated second ring 306D extends from the upstream surface 416 in the downstream direction to a cylindrical inner surface 600, which extends in a planar manner in the downstream direction. For example, such an orientation of the cylindrical inner surface 600 may increase an area of contact with the reciprocating element 202 to improve the sealed engagement between the packing arrangement 300 and the reciprocating element 202. The second downstream surface 424 extends from the cylindrical inner surface 600 in the downstream direction and is oriented transverse to the cylindrical inner surface 600 to form the downstream side 420 having the chevron configuration. Thus, the arcuate inner surface 428 of the second ring 306D terminates prior to the second downstream surface 424.

FIG. 4E illustrates the first ring 304 engaged with a fifth embodiment of the second ring 306E. The upstream surface 416 of the illustrated second ring 306E is convex instead of planar. That is, the upstream surface 416 extends in an upstream direction toward the first ring 304. Such an arrangement of the upstream surface 416 may facilitate sealed engagement with the first ring 304. For instance, the upstream surface 416 having the convex configuration may better contact and compress against the planar downstream surface 410 of the first ring 304. Consequently, fluid flow and/or debris entrapment between the first ring 304 and the second ring 306E may be reduced.

FIG. 4F illustrates the first ring 304 engaged with a sixth embodiment of the second ring 306F. The upstream surface 416 of the illustrated second ring 306E is concave and extends in the downstream direction. As an example, the upstream surface 416 may extend arcuately. As another example, the upstream surface 416 may include linear or planar sections (e.g., forming a female chevron) that extend in the downstream direction. The upstream surface 416 having the concave configuration may facilitate movement of the arcuate inner surface 428 in a radially inward direction toward the reciprocating element 202 upon compressing the first ring 304 against the upstream surface 416. For instance, compressing the first ring 304 against the upstream surface 416 may expand the upstream surface 416 to become more planar. The expansion of the upstream surface 416 may then move the arcuate inner surface 428 inwardly to increase engagement with the reciprocating element 202.

It should be noted that an embodiment of the second ring 306 may include any of the various features discussed herein. In other words, different combinations of the discussed features of the second ring 306 may be incorporated. Furthermore, a second ring 306 may have different features in an additional or alternative embodiment. By way of example, for another embodiment of the second ring 306, the arcuate inner surface 428 may extend to a tapered upstream surface that extends radially inward in the downstream direction. However, in any of such embodiments, the second ring 306 includes the arcuate inner surface 428 that extends directly and convexly from (e.g., is adjoined to) the upstream surface 416 to avoid creating a pedestal facing a reciprocating element.

While the disclosure has been illustrated and described in detail and with reference to specific embodiments thereof, it is nevertheless not intended to be limited to the details shown, since it will be apparent that various modifications and structural changes may be made therein without departing from the scope of the disclosure and within the scope and range of equivalents of the claims. In addition, various features from one of the embodiments may be incorporated into another of the embodiments. Accordingly, it is appropriate that the appended claims be construed broadly and in a manner consistent with the scope of the disclosure as set forth in the following claims.

Similarly, it is intended that the present disclosure cover the modifications and variations of this disclosure that come within the scope of the appended claims and their equivalents. For example, it is to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points of reference and do not limit the present disclosure to any particular orientation or configuration. Further, the term “exemplary” is used herein to describe an example or illustration. Any embodiment described herein as exemplary is not to be construed as a preferred or advantageous embodiment, but rather as one example or illustration of a possible embodiment of the disclosure.

Finally, when used herein, the term “comprises” and its derivations (such as “comprising”, etc.) should not be understood in an excluding sense; that is, these terms should not be interpreted as excluding the possibility that what is described and defined may include further elements, steps, etc. Meanwhile, when used herein, the term “approximately” and terms of its family (such as “approximate”, etc.) should be understood as indicating values very near to those which accompany the aforementioned term. That is to say, a deviation within reasonable limits from an exact value should be accepted, because a skilled person in the art will understand that such a deviation from the values indicated is inevitable due to measurement inaccuracies, etc. The same applies to the terms “about” and “around” and “substantially”. Also, any ranges provided herein should be understood to include their bounds, so that, for example, a range of 80-90 includes both 80 and 90.

1. A sealing ring for a packing arrangement of a reciprocating pump, the sealing ring comprising:
a planar upstream surface;
a tapered downstream surface disposed opposite of the planar upstream surface; and
an arcuate inner surface extending convexly from the planar upstream surface toward the tapered downstream surface, wherein the arcuate inner surface is configured to engage with a reciprocating element of the reciprocating pump.

2. The sealing ring of claim 1, wherein the planar upstream surface and the arcuate inner surface cooperatively form a vertex.

3. The sealing ring of claim 1, wherein the tapered downstream surface extends transverse to the planar upstream surface.

4. The sealing ring of claim 1, comprising an extension extending from the tapered downstream surface in a downstream direction.

5. The sealing ring of claim 1, comprising an outer surface extending opposite of the arcuate inner surface.

6. The sealing ring of claim 5, comprising an additional tapered downstream face extending from the outer surface toward the tapered downstream surface in a downstream direction.

7. The sealing ring of claim 1, comprising an additional inner surface extending from the arcuate inner surface to the tapered downstream surface.

8. The sealing ring of claim 1, wherein the arcuate inner surface terminates prior to the tapered downstream surface.

9. A sealing ring assembly for a packing arrangement of a reciprocating pump, the sealing ring assembly comprising:
a first ring comprising a downstream surface; and
a second ring comprising:
an upstream surface configured to engage the downstream surface of the first ring; and
an inner surface extending arcuately and convexly from the upstream surface in a downstream direction.

10. The sealing ring assembly of claim 9, wherein the second ring comprises a tapered downstream surface extending from the inner surface, and the sealing ring assembly comprises a third ring comprising a tapered upstream surface configured to engage the tapered downstream surface of the second ring and extend over the inner surface of the second ring.

11. The sealing ring assembly of claim 9, wherein the inner surface of the second ring extends radially inward beyond the first ring.

12. The sealing ring assembly of claim 9, wherein the upstream surface of the second ring extends radially outward beyond the downstream surface of the first ring.

13. The sealing ring assembly of claim 9, wherein the upstream surface of the second ring extends toward the downstream surface of the first ring.

14. The sealing ring assembly of claim 9, wherein the upstream surface of the second ring is arcuate.

15. The sealing ring assembly of claim 9, wherein the downstream surface of the first ring is planar.

16. A sealing ring for a packing arrangement of a reciprocating pump, the sealing ring comprising:
an upstream surface;
an arcuate inner surface extending convexly from the upstream surface, wherein the arcuate inner surface is configured to engage with a reciprocating element of the reciprocating pump; and
a downstream surface extending from the arcuate inner surface.

17. The sealing ring of claim 16, wherein the upstream surface is convex.

18. The sealing ring of claim 16, wherein the upstream surface is concave.

19. The sealing ring of claim 16, wherein the upstream surface is planar.

20. The sealing ring of claim 16, comprising:
an outer surface extending opposite of the arcuate inner surface; and
a tapered portion extending from the upstream surface to the outer surface.
